(19) United States
(12) Patent Application Publication
(10) Pub. No.: US 2015/0275047 A1
(43) Pub. Date: Oct. 1, 2015

(54) HIGH PUFA OILS FOR INDUSTRIAL APPLICATIONS

(71) Applicant: MONSANTO TECHNOLOGY LLC, Saint Louis, MO (US)

(72) Inventors: Frederico Tripodi, St. Louis, MO (US); Lou A. T. Honary, St. Louis, MO (US); Jerald D. Heise, St. Louis, MO (US)

(73) Assignee: Monsanto Technology LLC, St. Louis, MO (US)

(21) Appl. No.: 14/438,169

(22) PCT Filed: Oct. 17, 2013
(86) PCT No.: PCT/US2013/065371

§ 371 Date: Apr. 23, 2015

Related U.S. Application Data
(60) Provisional application No. 61/717,860, filed on Oct. 24, 2012.

(51) Int. Cl. C09D 191/00; B05D 7/06

(52) U.S. Cl. CPC C09D 191/005; B05D 7/06

(57) ABSTRACT

Oil compositions having a high concentration of polyunsaturated fatty acids are described for use in various applications including use as drying oils and polymeric coating. Oil compositions useful as a drying oil for wood compositions and for use as polymeric compositions.

### FIELD OF THE INVENTION

The present invention is directed to oil compositions of stearidonic acid derived from transgenic soybeans and their use as drying oils and polymerization compounds for wood products.

### BACKGROUND

The present invention provides a process whereby a transgenic plant oil with a unique fatty acid composition (rich in double-bonds, from SDA fatty acid), “SDA soybean oil” is used as a carrier of preservatives for enhanced treatment of wood or other surfaces like glass and metals, by itself or in combination with other plant or mineral oils. Mineral oils blended with active ingredients such as creosote with copper naphtenlate are widely used in the wood treatment industry, albeit less so due to environmental concerns in certain applications. Multiple industries that utilize creosote treated woods have been searching for cost effective, high performing environmentally friendly choices. Structural materials such as steel, concrete, plastic or composite materials (1), which in many cases tend to have significant cost implications need additional environmental protection to enhance their longevity and prevent degradation. Vegetable oils including linseed and soybean oil have been used as carrier of preservatives and as water barrier in wood treatment for many years. But, they present significant challenges due to a long required curing time and presenting a persistently sticky outer surface that delay delivery and increases the cost of delivered products. In one instance prolonged drying times/wood stickiness could result in contamination by objects such as leaves or dust blown by wind when stored outdoors or in large facilities.

The use of a vegetable, a renewable oil with superior drying characteristics and that forms a non-sticky polymerized coat to treat and protect the wood in lieu or in combination with creosote or other oils would also be a step change in wood treatment applications. According to the current invention the properties of this oil effectively “seal” active ingredients in the coating and thereby act to preserve and protect the underlying wood or metal object. Such ingredients could, including other oils such as creosote, create a superior protective plastic plasticized polymer coating in the surface of the wood, potentially requiring less oil to treat the wood, and, if used in conjunction with other environmentally friendly wood treatment agents, significantly reduce cost and environmental impact of disposition of old used treated wood, possibly enabling further recycling/energy opportunities.

Typically drying oils are organic liquids which, when applied as a thin film, readily absorb oxygen from the air and polymerize to form a relatively tough, elastic film. The base material for traditional drying oils are usually natural products from resources such as linseed oil, tung oil, commodity soybean oil, tall oil, dehydrated castor oil, and the like which are included as combinations of such natural oils or their fatty acids in various synthetic resins. The drying ability is due to the presence of unsaturated fatty acids, especially linoleic and linolenic, frequently in the form of glycerides but also as their corresponding carboxylic acids.

The applications for the current invention in the wood treatment industry are broad, of the instant invention include treated wooden utility posts, railway ties, outdoor wooden constructs, commercial/residential wood treatment, sealants, varnishes and architectural coatings.

### SUMMARY OF THE INVENTION

The present disclosure includes the incorporation of oil from transgenic plants engineered to contain significant quantities of stearidonic acid (18:4n-3) (SDA) for use in industrial applications, particularly those with wood products. Among the various aspects of the invention are uses of oil compositions as superior drying oils. Other long chain PUFA's could likewise be used for the purposes of the current invention.

One of the various aspects of the current invention is an oil composition comprising at least one polyunsaturated fatty acid having three or more carbon-carbon double bonds or a derivative thereof, wherein the double bonds of the unsaturated fatty acid or fatty acids wherein the composition comprises at least 5.5 wt. % of the at least one polyunsaturated fatty acid having four or more carbon-carbon double bonds or a derivative thereof based upon the total weight of fatty acids or derivatives thereof in the composition, wherein the oil composition is derived from a transgenic plant.

Another of the various aspects is an oil composition comprising at least one polyunsaturated fatty acid having three or more carbon-carbon double bonds or a derivative thereof, wherein the composition comprises at least 5.5 wt. % of the at least one polyunsaturated fatty acid having four or more carbon-carbon double bonds or a derivative thereof based upon the total weight of fatty acids or derivatives thereof in the composition, wherein the oil composition is derived from a non-animal source.

Yet another of the various aspects is an oil composition comprising at least one polyunsaturated fatty acid having three or more carbon-carbon double bonds or a derivative thereof, wherein the composition comprises at least 0.5 wt. % of the at least one polyunsaturated fatty acid having four or more carbon-carbon double bonds or a derivative thereof based upon the total weight of fatty acids or derivatives thereof in the composition, wherein the oil composition is derived from genetically-modified seeds.

A further aspect is an oil composition comprising at least one polyunsaturated fatty acid having three or more carbon-carbon double bonds or a derivative thereof, wherein the composition comprises at least 7.5 wt. % stearidonic acid (SDA Soybean oil) or a derivative thereof based upon the total weight of fatty acids or derivatives thereof in the composition.

One additional application of the current include oil compositions with superior drying/curing times for the wood compositions so treated where the object is cured in a pressure treatment chamber. Yet another application of the current invention includes, the formation of a plasticized polymer coat on the wood, where the protective layer protects from deterioration, insects, rot, and environmental degradation. These applications and improved performance characteristics also are present when the oil compositions of the current invention are used in glass, metals and plastics. The formation of a plasticized polymer coat on a given material (EX: wooden object) creates a physical water tight barrier to prevent leaching of actives, preservatives, protectants, and creosote/mineral oils to the environment.

Yet another aspect of the current invention is if the oil compositions of the current invention are used in combination with other oils (like creosote), as a second sealer, will keep those oils in place inside the wood and improve upon the current oils.

Yet another aspect of the current invention is that the polymerization characteristics will lower amounts of oil needed to pressure treat wood to achieve the same results which will result in significant cost savings and reduce logistics efforts in the production of wooden or metallic objects that will be covered by the oil compositions of the current invention.

The current invention will accelerate the polymerization and drying times with pre-treatment of the oil using blown air or oxygen, heat (oven or microwave sources) and/or metal agents such as copper.

Yet another aspect of the current invention is that if the oil compositions of the invention are used for wood treatments instead of mineral oil treatments and in combination with other environmentally friendly compounds they will reduce environmental impact and disposal costs of used treated woods (landfill, transportation, etc) and enable use of treated woods for alternate uses such as recycling into manufactured wood products or energy generation (burning, enzymatic energy production from cellulosic biomass).

A further aspect is a paint composition comprising a pigment and a drying oil or a method for coating a substrate comprising applying a coating composition to the substrate, wherein the coating composition comprises a drying oil composition comprising at least one polyunsaturated fatty acid having three or more carbon-carbon double bonds or a derivative thereof, and wherein the drying oil composition comprises at least 0.5 wt. % of the at least one polyunsaturated fatty acid having four or more carbon-carbon double bonds or a derivative thereof based upon the total weight of fatty acids or derivatives thereof in the drying oil composition, wherein the drying oil composition is derived from genetically-modified seeds.

### BRIEF DESCRIPTION OF THE DRAWINGS

FIG. 1A is a picture showing that manufactured wood absorbs a large quantity of oil which when cured in an oven at 60 C and the oil becomes plasticized into a shiny film. FIG. 1B is a picture of a magnified cutaway section that shows a heavy coat of polymerized oil which is non-tacky.

FIG. 2 is a chemical structure of stearidonic acid showing physiological (with boxes) and chemical (without boxes) numbering conventions.

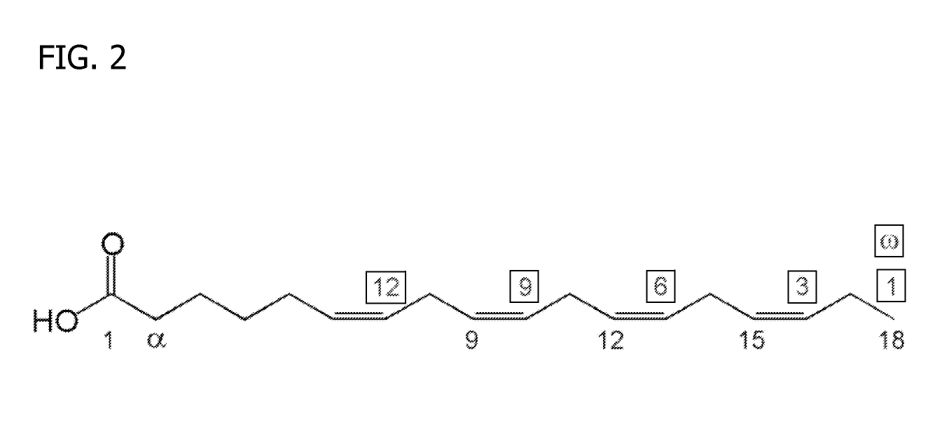

Corresponding reference characters indicate corresponding parts throughout the drawings.

### DETAILED DESCRIPTION

High polyunsaturated fatty acid (PUFA) oils have various unique characteristics that make them ideally suited to use as additives in various industrial compositions. According to the current invention they have surprising characteristics when used as drying oils in various coatings, particularly coatings for wood products that will dry in a period much faster than those seen in other conventional oils. The results of the present invention demonstrates the unique properties of SDA Soybean Oil in applications where a formation of a protective polymer coating would be beneficial and when fast drying of the oil, providing non-tacky surfaces will be desirable. The unique property shown by this oil of remaining liquid longer versus other plant oils tested while in volume but forming a very fast drying thin film polymer coating provides advantages for oil handling, logistics and equipment functioning as the oil only dries fast when it is applied in a thin film. Results show that multiple treatment conditions and combinations can meet or exceed oil retention levels of 7.5 pounds per cubic foot as specified by the American Wood Preservers Association Standards for creosote wood treatments, presenting commercial opportunities to provide renewable alternative utilizing existing equipment and achieving similar oil retention targets.

The results of the present invention confirm the unique properties of SDA Soybean Oil in applications where a formation of a protective polymer coating would be beneficial and when fast drying of the oil, providing non-tacky surfaces will be desirable. The unique property shown by this oil of remaining liquid longer versus other plant oils tested while in volume but forming a fast drying thin film polymer coating those oils provides advantages for oil handling, logistics and equipment functioning as the oil only dries fast when its applied in a thin film. Results show that multiple treatment conditions and combinations can meet or exceed oil retention levels of 7.5 pounds per cubic foot as specified by the American Wood Preservers Association Standards for creosote wood treatments, presenting commercial opportunities to provide renewable alternative utilizing existing equipment and achieving similar oil retention targets.

The oil composition can comprise at least about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44 or 45 wt. % or more of at least one polyunsaturated fatty acid having four or more carbon-carbon double bonds or a derivative thereof, based on the total weight of fatty acids or derivatives thereof in the composition. The oil composition can be derived from genetically-modified seeds. These genetically modified seeds include or could include seeds of Arabidopsis, canola, carrot, coconut, corn, cotton, flax, linseed, maize, palm kernel, peanut, potato, rapeseed, safflower, soybean, sunflower, and/or tobacco. The may produce omega-3 compositions such as SDA, EPA, DHA or others.

Also, the invention is directed to oil compositions comprising at least about 5.5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44 or 45 wt. % or more of at least one polyunsaturated fatty acid having four or more carbon-carbon double bonds or a derivative thereof based on the total weight of fatty acids or derivatives thereof in the composition wherein the oil composition is derived from a non-animal source, preferably a microalgae source that may be harvested from a fish or other animal.

The oil compositions of the invention can comprise at least 7.5, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44 or 45 wt. % or more stearidonic acid or a derivative thereof based upon the total weight of fatty acids or derivatives thereof in the composition.

The oil compositions useful for the invention can comprise from about 7.5 wt. % to about 60 wt. % stearidonic acid, from about 7.5 wt. % to about 40 wt. % stearidonic acid, from about 7.5 wt. % to about 30 wt. % stearidonic acid, from about 10 wt. % to about 60 wt. % stearidonic acid, from about 10 wt. % to about 40 wt. % stearidonic acid, or from about 10 wt. % to about 30 wt. % stearidonic acid.

### DEFINITIONS

As used herein a “plant cell” means a plant cell that is transformed with stably-integrated, non-natural, recombinant DNA, e.g. by Agrobacterium-mediated transformation or by bombardment using microparticles coated with recombinant DNA or other means. A plant cell of this invention can be an originally-transformed plant cell that exists as a microorganism or as a progeny plant cell that is regenerated into differentiated tissue, e.g. into a transgenic plant with stably-integrated, non-natural recombinant DNA, or seed or pollen derived from a progeny transgenic plant.

As used herein a “transgenic plant” includes a plant, plant part, plant cells or seed whose genome has been altered by the stable integration of recombinant DNA. A transgenic plant includes a plant regenerated from an originally-transformed plant cell and progeny transgenic plants from later generations or crosses of a transformed plant.

As used herein “recombinant DNA” means DNA which has been a genetically engineered and constructed outside of a cell.

Recombinant DNA constructs are assembled using methods well known to persons of ordinary skill in the art and typically comprise a promoter operably linked to DNA, the expression of which provides the enhanced agronomic trait. Other construct components may include additional regulatory elements, such as 5′ leaders and introns for enhancing transcription, 3′ untranslated regions (such as polyadenylation signals and sites), DNA for transit or signal peptides.

Exemplary polyunsaturated fatty acids, or derivatives thereof, having three or more double bonds are ALA 18:3 (n=3), CLA (conjugated linoleic acid) (18:3), GLA 18:3 (n=6), stearidonic acid (SDA, C18:4), eicosatetraenoic acid (ETA), eicosapentaenoic acid (EPA; C20:5), docosapentaenoic acid (DPA; C22:5), docosahexaenoic acid (DHA), and arachidonic acid (AA; C20:4). Preferably, the polyunsaturated fatty acid or derivative thereof of the above described oil compositions comprises at least one omega-3 or omega-6 fatty acid, and preferably comprises omega-3 stearidonic acid (SDA; C18:4), omega-3 eicosatetraenoic acid (ETA), omega-3 eicosapentaenoic acid (EPA; C20:5), omega-3 docosapentaenoic acid (DPA; C22:5), omega-3 docosahexaenoic acid (DHA; C22:6), or omega-6 arachidonic acid (AA; C20:4).

The compositions described above in this section can further comprise γ-linolenic acid or a derivative thereof (C-γ18:3), or DH-γ-linolenic acid (C-DH-γ20:3) or a derivative thereof.

Further, the oil compositions described herein can be derived from a plant oil other than blackcurrant oil, borage oil, Echium oil, evening primrose oil, gooseberry oil, hemp oil, or redcurrant oil. Moreover, the composition of the oils can be derived from oil other than fish (e.g., menhaden, sardine, tuna, cod liver, mackerel, or herring), algal oil or other marine oils. Algal groups that produce oils with four double bonds or more include chrysophytes, crytophytes, diatoms, and dinoflagellates (Behrens and Kyle, 1996: J. Food Lipids, 3:259-272) including oils derived from Crypthecodinium cohnii, Nitzchia sp, Nannochloropsis, Navicula sp., Phaedactylum, Porphyridium and Schizochytrium.

Additionally, the oil compositions described herein can be derived from genetically-modified Arabidopsis, canola, carrot, coconut, corn, cotton, flax, linseed, maize, palm kernel, peanut, potato, rapeseed, safflower, soybean, sunflower, and/or tobacco. Finally, the composition of the oils described above can be an unblended oil.

Some of the various oils of the present invention can be extracted from plant tissue, including plant seed tissue. Plants from which polyunsaturated fatty acids can be isolated include plants with native levels of polyunsaturated fatty acids as well as plants genetically engineered to express elevated levels of polyunsaturated fatty acids. Examples of plants with native levels of polyunsaturated fatty acids include oilseed crops, such as canola, safflower, and linseed, as well as plants such as flax, evening primrose (Oenothera biennis), borage (Borago officinalis) and black currants (Ribes nigrum), Trichodesma, and Echium. Certain mosses, for example Physcomitrella patens, are known to natively produce polyunsaturated fatty acids that can be extracted and purified. As another example, the polyunsaturated fatty acid compositions (including for example, stearidonic acid, docosahexaenoic acid, eicosapentaenoic acid, gamma linolenic acid, arachidonic acid, dihomogammalinolenic acid, docosapentaenoic acid, and octadecatetraeonic acid) can be extracted from plants and/or recombinant plants (including for example, Arabidopsis, canola, carrot, coconut, corn, cotton, flax, linseed, maize, palm kernel, peanut, potato, rapeseed, safflower, soybean, sunflower, tobacco, and mixtures thereof) produced with, for example, the compositions and methods of U.S. Pat. Nos. 7,241,619; 7,211,656; 7,189,894; 7,070,970; 7,045,683; 6,858,416; 6,677,145; 6,683,232; 6,635,451; 6,566,583; 6,459,018; 6,432,684; 6,355,861; 6,075,183; 5,977,436; 5,972,664; 5,968,809; 5,959,175; 5,689,050; 5,614,393; 5,552,306; and 5,443,974, as well as WO 02/26946; WO 98/55625; WO 96/21022, and also U.S. Patent App. Ser. Nos. 2006/0265778; 2006/0156435; 20040078845; 20030163845; and 20030082754 (the prior references are herein incorporated by reference).

Other oil compositions can be extracted from fungi. Fungi from which polyunsaturated fatty acids can be isolated include fungi with native levels of polyunsaturated fatty acids as well as fungi genetically engineered to express elevated levels of polyunsaturated fatty acids. For example, oils having polyunsaturated fatty acid (including stearidonic acid, docosahexaenoic acid, eicosapentaenoic acid, gamma linolenic acid, arachidonic acid, dihomogammalinolenic acid, docosapentaenoic acid, and octadecatetraeonic acid) can be extracted from fungi and/or recombinant fungi (including for example, Saccharomyces (including S. cerevisiae and S. carlsbergensis), Candida spp., Cunninghamella spp. (including C. elegans, C. blakesleegna, and C. echinulate), Lipomyces starkey, Yarrowia lipolytica, Kluyveromyces spp., Hansenula spp., Aspergillus spp., Penicillium spp., Neurospora spp., Saprolegnia diclina, Trichoderma spp., Thamnidium elegans, Pichia spp., Pythium spp. (including P. ultimum, P. debaryanum, P. irregulare, and P. insidiosum), Thraustochytrium aureum, and Mortierella spp. (including M. elongata, M. exigua, M. hygrophila, M. ramanniana, M. ramanniana var. angulispora, M. ramanniana var. nana, M. alpina, M. isabellina, and M. vinacea)) produced with, for example, the compositions and methods of U.S. Pat. Nos. 7,241,619; 7,211,656; 7,189,894; 7,070,970; 6,858,416; 6,677,145; 6,635,451; 6,607,900; 6,566,583; 6,432,684; 6,410,282; 6,355,861; 6,280,982; 6,255,505; 6,136,574; 5,972,664; 5,968,809; 5,658,767; 5,614,393; 5,376,541; 5,246,842; 5,026,644; 4,871,666; and 4,783,408; as well as WO 02/26946; and also U.S. Patent App. Ser. Nos. 20040078845; 20030163845; and 20030082754 (the prior references are herein incorporated by reference).

Yet other oil compositions can be extracted from microorganisms. Microorganisms from which polyunsaturated fatty acids can be isolated include microorganisms with native levels of polyunsaturated fatty acids as well as microorganisms genetically engineered to express elevated levels of polyunsaturated fatty acids. Such microorganisms include bacteria and cyanobacteria. For example, oils having polyunsaturated fatty acid (including stearidonic acid, docosahexaenoic acid, eicosapentaenoic acid, gamma linolenic acid, arachidonic acid, dihomogammalinolenic acid, docosapentaenoic acid, and octadecatetraeonic acid) can be extracted from microorganisms and/or recombinant microorganisms, including for example E. coli, Cyanobacteria, Lactobacillus, and Bacillus subtilis, produced with, for example, the compositions and methods of U.S. Pat. Nos. 7,189,894; 7,070,970; 6,858,416; 6,677,145; 6,635,451; 6,607,900; 6,566,583; 6,432,684; 5,972,664; 5,614,393; and 5,552,306, as well as WO 02/26946; and also U.S. Patent App. Ser. Nos. 20040078845; 20030180898; 20030163845; and 20030082754 (the prior references are herein incorporated by reference).

Additionally, oil compositions can be extracted from algae. Algae from which polyunsaturated fatty acids can be isolated include algae with native levels of polyunsaturated fatty acids as well as algae genetically engineered to express elevated levels of polyunsaturated fatty acids. Examples of algae with native levels of polyunsaturated fatty acids include Phaeodactylum tricornutum, Crypthecodinium cohnii, Pavlova, Isochrysis galbana, and Thraustochytrium. For example, oils having polyunsaturated fatty acids (including stearidonic acid, docosahexaenoic acid, eicosapentaenoic acid, gamma linolenic acid, arachidonic acid, dihomogammalinolenic acid, docosapentaenoic acid, and octadecatetraeonic acid) can be extracted from alga and/or recombinant alga produced with, for example, the compositions and methods of U.S. Pat. Nos. 7,070,970; 7,045,683; 6,986,323; 6,727,373; 6,607,900; 6,566,583; 6,255,505; 6,136,574; 5,972,664; 5,968,809; 5,547,699; and 5,407,957; and also U.S. patent App. Ser. Nos. 20030180898; and 20030163845 (the prior references are herein incorporated by reference).

In order to prepare the oil compositions described above from a transgenic plant, specifically soybeans include the following steps are generally used to process seed oils: preparation, cracking and dehulling, conditioning, milling, flaking or pressing, extracting, degumming, refining, bleaching and deodorizing. Each of these steps will be discussed in more detail herein below. This discussion details the current commercial process for each of the steps from soybean. A person of ordinary skill would know that the steps could be combined, used in a different order or otherwise modified depending upon the crop from which the oil is extracted and the use for which it is destined.

Generally, the preparation step includes the initial seed cleaning process, which removes stones, dirt, sticks, worms, insects, metal fragments, and other debris collected during the harvest and storage of the seeds. Extraneous matter as described above can affect the quality of the final seed oil by containing compounds that negatively impact its chemical stability. Preferably, ripe, unbroken seeds having reduced levels of chlorophyll, are properly dried and with reduced levels of free fatty acids are used.

After the preparation step, the seeds are cracked and dehulled. Cracking and dehulling can be accomplished in a variety of ways, which are well known in the art. For example, the seeds can be cracked and dehulled using a seed cracker, which mechanically breaks the seeds and releases hulls and generates some fines. After cracking, the hulls and fines can be separated from the seed meats by a dehuller. In one aspect, the dehuller can separate the hulls from the seed meats due to the density difference between the hulls and the seeds; the hulls are less dense than the seed meats. For example, aspiration will separate the hulls from the cracked seed meats. Dehulling reduces the crude fiber content, while increasing the protein concentration of the extracted seed meats. Optionally, after dehulling, the hulls can be sieved to recover the fines generated in the cracking of the seeds. After recovery, the fines can be added back to the seed meats prior to conditioning or they can be added directly to the extractor.

Once the seeds are cracked, the oxygen exposure of the seed meats can optionally be minimized, which would reduce oil oxidation and improve oil quality. Furthermore, it will be understood by persons skilled in the art that minimization of oxygen exposure may occur independently at each of the subsequently disclosed oilseed processing steps.

Once the seeds are cracked and dehulled, they are conditioned to make the seed meats pliable prior to further processing. Furthermore, the conditioning promotes rupturing of oil bodies. Further processing, in terms of flaking, grinding or other milling technology is made easier by having pliable seed meats at this stage. Generally, the seed meats have moisture removed or added in order to reach a 6-14 wt. % moisture level. If moisture is removed, this process is called toasting or drying and if moisture is added, this process is called cooking or tempering. Typically, the seed meats are heated to 40-90° C. with steam which is dry or wet depending on the direction of adjustment of the moisture content of the seed meats. In some instances, the conditioning step occurs under conditions minimizing oxygen exposure or at lower temperatures for seeds having high PUFA levels.

Once the seed meats are conditioned, they can be milled to a desired particle size or flaked to a desired surface area. In certain cases, the flaking or milling occurs under conditions minimizing oxygen exposure. Flaking or milling is done to increase the surface area of the seed meats and also rupture the oil bodies thereby facilitating a more efficient extraction. Many milling technologies are appropriate and are well known in the art. The considerations when choosing a method of milling and a particle size for the ground seed are contingent upon, but not limited to the oil content in the seed and the desired efficiency of the extraction of the seed meats or the seed. When flaking the seed meats, the flakes are typically from about 0.1 to about 0.5 mm thick; from about 0.1 to about 0.35 mm thick; from about 0.3 to about 0.5 mm thick; or from about 0.2 to about 0.4 mm thick.

Optionally, after the seed meats are milled, they can be pressed. Typically, the seed meats are pressed when the oil content of the seed meats is greater than about 30 wt. % of the seeds. However, seeds with higher or lower oil contents can be pressed. The seed meats can be pressed, for example, in a hydraulic press or mechanical screw. Typically, the seed meats are heated to less than about 55° C. upon the input of work. When pressed, the oil in the seed meats is pressed through a screen, collected and filtered. The oil collected is the first press oil. The seed meats from after pressing are called seed cake; the seed cake contains oil and can be subjected to solvent extraction.

After milling, flaking or optional pressing, the oil can be extracted from the seed meats or seed cake by contacting them with a solvent. Preferably, n-hexane or iso-hexane is used as the solvent in the extraction process. Typically, the solvent is degassed prior to contact with the oil. This extraction can be carried out in a variety of ways, which are well known in the art. For example, the extraction can be a batch or continuous process and desirably is a continuous counter-current process. In a continuous counter-current process, the solvent contact with the seed meat leaches the oil into the solvent, providing increasingly more concentrated miscellas (i.e., solvent-oil), while the marc (i.e., solvent-solids) is contacted with miscellas of decreasing concentration. After extraction, the solvent is removed from the miscella in a manner well known in the art. For example, distillation, rotary evaporation or a rising film evaporator and steam stripper can be used for removing the solvent. After solvent removal, if the crude oil still contains residual solvent, it can be heated at about 95° C. under reduced pressure at about 60 mmHg.

According to the current invention, the above processed crude soybean oil contains hydratable and nonhydratable phosphatides. Accordingly, the crude oil is degummed to remove the hydratable phosphatides by adding water and heating to from about 40 to about 75° C. for approximately 5-60 minutes depending on the phosphatide concentration. Optionally, phosphoric acid and/or citric acid can be added to convert the nonhydratable phosphatides to hydratable phosphatides. Phosphoric acid and citric acid form metal complexes, which decreases the concentration of metal ions bound to phosphatides (metal complexed phosphatides are nonhydratable) and thus, converts nonhydratable phosphatides to hydratable phosphatides. Optionally, after heating with water, the crude oil and water mixture can be centrifuged to separate the oil and water, followed by removal of the water layer containing the hydratable phosphatides. Generally, if phosphoric acid and/or citric acid are added in the degumming step, about 1 wt. % to about 5 wt. %; preferably, about 1 wt. % to about 2 wt. %; more preferably, about 1.5 wt. % to about 2 wt. % are used. This process step is optionally carried out by degassing the water and phosphoric acid before contacting them with the oil to remove oxygen in order to minimize oxidation thus maximizing oil quality.

Furthermore, the crude oil contains free fatty acids (FFAs), which can be removed by a chemical (e.g., caustic) refining step. When FFAs react with basic substances (e.g., caustic) they form carboxylic acid salts or soaps that can be extracted into aqueous solution. Thus, the crude oil is heated to about 40 to about 75° C. and NaOH is added with stirring and allowed to react for approximately 10 to 45 minutes. This is followed by stopping the stirring while continuing heat, removing the aqueous layer, and treating the neutralized oil to remove soaps. The oil is treated by water washing the oil until the aqueous layer is of neutral pH, or by treating the neutralized oil with a silica or ion exchange material. The oil is dried at about 95° C. and about 10 mmHg. In some instances, the caustic solution is degassed before it contacts the oil.

Alternatively, rather than removing FFAs from the oil by chemical refining, the FFAs can be removed by physical refining. For example, the oil can be physically refined during deodorization. When physical refining is performed, the FFAs are removed from the oil by vacuum distillation performed at low pressure and relatively higher temperature. Generally, FFAs have lower molecular weights than triglycerides and thus, FFAs generally have lower boiling points and can be separated from triglycerides based on this boiling point difference and through aid of nitrogen or steam stripping used as an azeotrope or carrier gas to sweep volatiles from the deodorizers.

Typically, when physical refining rather than chemical refining is performed, oil processing conditions are modified to achieve similar final product specifications. For example, when an aqueous acidic solution is used in the degumming step, a higher concentration of acid (e.g., up to about 100% greater concentration, preferably about 50% to about 100% greater concentration) may be needed due to the greater concentration of non-hydratable phosphatides that could otherwise be removed in a chemical refining step. In addition, a greater amount of bleaching material (e.g., up to about 100% greater amount, preferably about 50 to about 100% greater amount) is used.

Before bleaching citric acid (50 wt. % solution) can be added at a concentration of about 0.01 wt. % to about 5 wt. % to the degummed oil and/or chemically refined oil. This mixture can then be heated at a temperature of about 35° C. to about 65° C. and a pressure of about 1 mmHg to about 760 mmHg for about 5 to about 60 minutes.

The degummed oil and/or chemically refined oil is subjected to an absorption process (e.g., bleached) to remove peroxides, oxidation products, phosphatides, keratinoids, chlorphyloids, color bodies, metals and remaining soaps formed in the caustic refining step or other processing steps. The bleaching process comprises heating the degummed oil or chemically refined oil under vacuum of about 0.1 mmHg to about 200 mmHg and adding a bleaching material appropriate to remove the above referenced species (e.g., neutral earth (commonly termed natural clay or fuller's earth), acid-activated earth, activated clays and silicates) and a filter aid, whereupon the mixture is heated to about 75-125° C. and the bleaching material is contacted with the degummed oil and/or chemically refined oil for about 5-50 minutes. It can be advantageous to degas the bleaching material before it contacts the refined oil. The amount of bleaching material used is from about 0.25 wt. % to about 3 wt. %, preferably about 0.25 wt. % to about 1.5 wt. %, and more preferably about 0.5 wt. % to about 1 wt. %. After heating, the bleached oil or refined, bleached oil is filtered and deodorized.

The bleached oil or refined, bleached oil is deodorized to remove compounds with strong odors and flavors as well as remaining free fatty acids. The color of the oil can be further reduced by heat bleaching at elevated temperatures. Deodorization can be performed by a variety of techniques including batch and continuous deodorization units such as batch stirred tank reactors, falling film evaporators, wiped film evaporators, packed column deodorizers, tray type deodorizers, and loop reactors. Typically, a continuous deodorization process is preferred. Generally, deodorization conditions are performed at about 160 to about 270° C. and about 0.002 to about 1.4 kPa. For a continuous process, particularly in a continuous deodorizer having successive trays for the oil to traverse, a residence time of up to 2 hours at a temperature from about 170° C. to about 265° C.; a residence time of up to about 30 minutes at a temperature from about 240° C. to about 250° C. is preferred. Deodorization conditions can use carrier gases for the removal of volatile compounds (e.g., steam, nitrogen, argon, or any other gas that does not decrease the stability or quality of the oil).

Furthermore, when physical rather than chemical refining is used, a greater amount of FFAs are removed during the deodorization step, and the deodorizer conditions are modified to facilitate the removal of free fatty acids. For example, the temperature is increased by about 25° C.; oils can be deodorized at temperatures ranging from about 165° C. to about 300° C. In particular, oils can be deodorized at temperatures ranging from about 250° C. to about 280° C. or about 175° C. to about 205° C. In addition, the retention time of the oil in the deodorizer is increased by up to about 100%. For example, the retention time can range from less than about 1, 5, 10, 30, 60, 90, 100, 110, 120, 130, 150, 180, 210 or 240 minutes. Additionally, the deodorizer pressure can be reduced to less than about 3×10⁻⁴, 1×10⁻³, 5×10⁻³, 0.01, 0.02, 0.03, 0.04, 0.05, 0.06, 0.07, 0.08, 0.09, or 0.1 kPa. The deodorization step results in refined, bleached and deodorized (RBD) oil.

Optionally, RBD oils can be stabilized by partial hydrogenation and/or by the addition of stabilizers or by minimizing the removal or degradation of microcomponents that aid in maintaining oil stability and quality. Partial hydrogenation stabilizes an oil by reducing the number of double bonds in the fatty acids contained in the oil and thus, reducing the chemical reactivity of the oil. However, partial hydrogenation can increase the concentration of undesirable trans-fatty acids.

Stabilizers generally act to intercept free radicals formed during oxidation. Interception of the free radicals by stabilizers, which become either more stable free radicals or rearrange to become stable molecules, slows the oxidation of the oil due to the decreased concentration of highly reactive free radicals that can oxidize more fatty acid units.

For each of the above steps, at each step the exposure to oxygen was optionally minimized, the exposure to heat was optionally minimized, the exposure to UV light was optionally minimized and optionally, stabilizers were added to the seed meats or seed oil before, during, or after processing. These and other process improvements for preparing oils of the present invention are described and exemplified in U.S. patent application Ser. No. 11/267,810 entitled “Processes for Preparation of Oil Compositions” filed Nov. 4, 2005, which is incorporated by reference herein in its entirety.

### Drying Oils

A drying oil is an oil that hardens and dries to a tough, solid film after a period of exposure to air. Although called a drying oil, the oil does not harden through the evaporation of water or other solvents, but through a chemical reaction in which oxygen is absorbed from the environment (autoxidation). Drying oils are a key component of oil paint and many varnishes. Some commonly used drying oils include linseed oil, commodity soybean oil, tung oil, poppy seed oil, perilla oil and walnut oil.

The “drying”, hardening, or, more properly, curing of oils is the result of an exothermic reaction in the form of autoxidation. In this process, oxygen oxidizes the hydrocarbon chain, initiating a series of chemical reactions. As a result, the oil polymerizes, cross-links, and bonds form between neighboring molecules, resulting in a polymer network. Conceptually, this network equates to a fusing of individual, randomly interlocking, strands into a cohesive mass or, in the case of varnishes and paints, into a solid film. Over time, this network may undergo further change. Certain functional groups in the networks become ionized, and the network transitions from a system held together by nonpolar covalent bonds to one governed by the ionic forces between these functional groups and the metal ions present in the pigment.

Vegetable oils consist of glycerol esters of fatty acids, which are long hydrocarbon chains with a terminal carboxyl group. In oil autoxidation, oxygen attacks a hydrocarbon chain, often at the site of allylic hydrogen (a hydrogen on a carbon atom adjacent to a double bond). This produces a free radical, a substance with an unpaired electron which makes it highly reactive. A series of addition reactions ensue. Each step produces additional free radicals, which then engage in further polymerization. The process finally terminates when free radicals collide, combining their unpaired electrons to form a new bond. The polymerization stage occurs over a period of days to weeks, and renders the film dry to the touch.

Because the oil compositions of the invention are highly unsaturated, they can be used as drying oils. Typically, these oils are used in coating compositions (e.g., paint, varnish, etc.) at concentrations of up to 100 wt. %. In various formulations, the coating composition can include pigments and other additives at low concentrations. In those formulations, the concentration of the drying oil would be decreased accordingly.

The drying oil can be boiled, which is heating the oil with bubbling of oxygen to speed the drying process by pre-oxidizing the oil. Oxidation catalysts, typically metal naphthenates, can also be added in order to accelerate cure.

Useful coatings, inks, sealants, or adhesives form when highly unsaturated drying oils participate in free-radical homopolymerizations or copolymerizations with other vinylic monomers. The polymerizations may be carried out in the absence of solvent (in bulk), in solution, or aqueous emulsion depending on the use intended. Thus, bulk polymerization would be preferred, for example, if a liquid composition containing the highly unsaturated drying oils described above was to be a solventless coating that is polymerized and cured in place. Still another application of bulk polymerization would be as reactive diluents in solventless coatings, sealant or adhesive formulations. Copolymers made with highly unsaturated drying oils made in solution would be useful as a binder in traditional solvent-based coatings, high solids coatings or, depending on the nature of the diluent, as an intermediate stage in the preparation of water reducible coatings. Emulsion copolymers made with highly unsaturated drying oils are useful in a range of applications including paints, inks, sealants and adhesives. The presence of highly unsaturated drying oils in these systems imparts the ability to cure oxidatively under ambient conditions to provide solvent and water resistance as well as reduced critical film-forming temperatures.

### Wood Compositions

One aspect of the present invention is directed to coating compositions containing oil compositions described herein. Such preservative compositions are useful in various applications provided herein.

The compositions of the invention can also contain rheological modifiers such as gelling agents to help lower the misting properties of a spray application and contribute to a faster drying and better polymerization activities as well as controlling the flow properties of the compound. Such gelling agents are typically organometallic compounds of aluminum or polyamide resins. Preferred gelling agents for the ink compositions are the organometallic compounds of aluminum, in particular, aluminum soaps, aluminum alkoxides or oxyaluminum acylates, most preferably, oxyaluminum acylates such as oxyaluminum octoate. When utilizing a gelling agent in the for the compositions of the current invention, the composition is desirably manufactured under an inert atmosphere, the gelling agent is pre-diluted with the solvent and the pre-diluted gelling agent is slowly added to the other components of the composition.

An oil composition can be heat treated by heating at a temperature of from about 300° C. to about 335° C. In the case of a black composition carbon black (preferably, Elftex carbon black from Cabot Corp.) can be used as the pigment.

Exemplary stabilizers can include 2,4,5-trihydroxybutyrophenone, 2,6-di-t-butylphenol, 3,4-dihydroxybenzoic acid, 3-t-butyl-4-hydroxyanisole, 4-hydroxymethyl-2,6-di-t-butylphenol, 6-ethoxy-1,2-dihydro-2,2,4-trimethylquinoline, anoxomer, ascorbic acid, ascorbyl palmitate, ascorbyl stearate, beta-apo-8′-carotenoic acid, beta-carotene, butylated hydroxyanisole (BHA), butylated hydroxytoluene (BHT), caffeic acid, calcium ascorbate, calcium disodium EDTA, canthaxanthin, carnosol, carvacrol, catalase, cetyl gallate, chlorogenic acid, citric acid, clove extract, coffee bean extract, D-α-tocopheryl acetate, dilauryl thiodipropionate, disodium citrate, disodium EDTA, DL-α-tocopherol, DL-α-tocopheryl acetate, dodecyl gallate, dodecyl gallate, D-α-tocopherol, edetic acid, erythorbic acid, esculetin, esculin, ethoxyquin, ethyl gallate, ethyl maltol, eucalyptus extract, ferulic acid, flavonoids (characterized by a carbon skeleton like C₆-C₃-C₆, typically two aromatic rings linked by a three carbon aliphatic chain which is normally condensed to form a pyran or less commonly a furan ring), flavones (such as apigenin, chrysin, luteolin), flavonols (such as datiscetin, nyricetin, daemfero), flavanones, chalcones, fraxetin, fumaric acid, gentian extract, gluconic acid, glucose oxidase, heptyl paraben, hesperetin, hydroquinone, hydroxycinammic acid, hydroxyglutaric acid, hydroxytryrosol, isopropyl citrate, lecithin, lemon juice solids, lemon juice, L-tartaric acid, lutein, lycopene, malic acid, maltol, methyl gallate, methylparaben, morin, N-hydroxysuccinic acid, nordihydroguaiaretic acid, octyl gallate, p-coumaric acid, phosphatidylcholine, phosphoric acid, p-hydroxybenzoic acid, phytic acid (inositol hexaphosphate), pimento extract, potassium bisulfite, potassium lactate, potassium metabisulfite, potassium sodium tartrate anhydrous, propyl gallate, pyrophospate, quercetin, ice bran extract, rosemary extract (RE), rosmarinic acid, sage extract, sesamol, sinapic acid, sodium ascorbate, sodium ascorbate, sodium erythorbate, sodium erythorbate, sodium hypophosphate, sodium hypophosphate, sodium metabisulfite, sodium sulfite, sodium thisulfate pentahydrate, sodium tryphosphate, soy flour, succinic acid, sucrose, syringic acid, tartaric acid, t-butyl hydroquinone (TBHQ), thymol, tocopherol, tocopheryl acetate, tocotrienols, trans-resveratrol, tyrosol, vanillic acid, wheat germ oil, zeaxanthin, α-terpineol, and combinations thereof.

One or more drying catalysts can be added to aid in the oxidation drying of the coating composition. Such drying catalysts are preferably metal salts of acylates or octoates, particularly cobalt and manganese metal salts.

The coating compositions described herein can be prepared in a conventional manner by mixing the components described herein to form a homogenous mixture. The properties of the coating compositions described herein can be tested by standard methods. Usually, the drying time, coating tack, rub resistance, misting, and water pickup of the compositions provide guidance in selecting and improving the coating formulations.

The drying oil described herein can be used to coat a wood product wherein the coating comprises a heat treated oil composition and the oil composition used for heat treatment comprises at least one polyunsaturated fatty acid having three or more carbon-carbon double bonds or a derivative thereof, and either: (a) at least 5.5 wt. % of at least one polyunsaturated fatty acid having four or more carbon-carbon double bonds or a derivative thereof and at least 16.5 wt. % of linoleic acid or a derivative thereof based upon the total weight of fatty acids or derivatives thereof in the heat treated oil composition; (b) at least 5.5 wt. % of at least one polyunsaturated fatty acid having four or more carbon-carbon double bonds or a derivative thereof, less than 14.5 wt. % of palmitic acid or a derivative thereof, and at least 3.5 wt. % linoleic acid or a derivative thereof based upon the total weight of fatty acids or derivatives thereof in the heat treated oil composition; (c) at least 7.5 wt. % stearidonic acid or a derivative thereof based upon the total weight of fatty acids or derivatives thereof in the heat treated oil composition; or (d) at least 20 wt. % gamma-linolenic acid or a derivative thereof based upon the total weight of fatty acids or derivatives thereof in the heat treated oil composition.

The drying oils described herein can have a viscosity index of from about 230 to about 270, from about 240 to about 260, or from about 245 to about 255.

Further, the drying oils described herein can have a viscosity index of from 230 to 270, from 240 to 260, or from 245 to 255. The viscosity index is determined using the ASTM D445 and ASTM D2270 standards.

Drying oils described herein can be used to coat wood articles wherein the wood articles comprise creosote and a drying oil derived from heat treating and SDA oil as described herein.

The drying oils comprising SDA oil useful for the wood coating compositions can resist formation of a polymerized film on top of the bulk liquid for at least 2, 3, 4, or more times longer than a drying oil that is otherwise identical except prepared from conventional linseed oil or soy oil.

The drying oils comprising SDA oil useful for the wood coating compositions polymerize to form a film when spread in a thin film at the same rate or faster than a drying oil that is otherwise identical except prepared from conventional linseed oil or soy oil.

The drying oils comprising a heat treated SDA oil comprise from 7.5 wt. % to 30 wt. % SDA in the oil composition.

These drying oils can further comprise a gelling agent as described above.

The drying oils derived from a SDA oil and comprising a gelling agent can further comprise a stabilizer as described herein.

### EXAMPLES

The following non-limiting examples are provided to further illustrate the present invention.

### Materials and Methods

### Experiment #1

### Materials

(1) Commodity Soybean Oil (control)
(2) Linseed Oil (control)—Winsor & Newton Cold-Pressed Linseed Oil #3222951
(3) SDA Soybean Oil treated with a known anti-oxidant
(4) Oxygen Blown/heated SDA Soybean Oil
(5) Polymerized Linseed Stand Oil (control)—Winsor & Newton Lot 03923 0263665
(6) Used Blown/heated SDA Soybean Oil

Methods

To generate materials for entries (4) and (6) immediately above, SDA Soybean Oil was blown with oxygen and heated to 190° C. (° F.) for 24 hours, with a copper catalyst added to the solution, this to promote oxidation of the oil. Oil from entry (6) represented remnants after using for pressure treating wood at 100° C. (212° F.) for an additional period of 12 hours. Thereafter 0.005 ml of each oil where measured and placed as a single drop (not a thin film) on top of a glass film and left in a room at room temperature (25 C) with no direct exposure to sunlight or circulating air for a period of 14 days. Stickiness and dryness to touch where measured at the end of the period.

### Experiment #1 Results

TABLE 1
Stickiness after 2 weeks of drying time at room temperature
Table 1: Stickiness after 2 weeks of drying time at room temperature

| Sample # | Sample | Scores on 10/7 (time zero) | Scores on 10/21 |
|---|---|---|---|
| 1 | Soybean Oil | Very wet, not sticky | Very wet, not sticky |
| | (control) | | |
| 2 | Linseed Oil (control) | Very wet, not sticky | Very wet, not sticky |
| 3 | SDA Soybean Oil | Very wet, not sticky | Very wet, slightly sticky |
| 4 | Blown/heated SDA | Very wet, not sticky | Dry, not sticky, formed a |
| | Soybean Oil | | polymer coat on glass |
| 5 | Polymerized Linseed | Very wet, extremely sticky | Wet, extremely sticky |
| | Stand Oil | | |
| 6 | Used Blown/heated | Very wet, not sticky | Dry, not sticky, formed a |
| | SDA Soybean Oil | | polymer coat on glass |

### Experiment #2

### Materials

(1) Soybean Oil (control)
(2) Linseed Oil (control)—Winsor & Newton Cold-Pressed Linseed Oil #3222951
(3) SDA Soybean Oil treated with a known anti-oxidant
(4) Air Blown/heated SDA Soybean Oil
(5) Polymerized Linseed Stand Oil (control)—Winsor & Newton Lot 03923 0263665

Methods

5 (Five) ml of each oil where placed each in a glass test tube and exposed them to 76.6, ° C. (170° F.) in an oven over a period of 10 hours, let stand at room temperature for 24 hours and then heated again at 76.6° C. for another 10 hours. Thereafter 0.005 ml of each oil where measured with a pipette, then placed on top of a glass film and manually spread using a fingertip in circular motion until achieving a thin film over the glass surface and exposed them to (170° F.) in an oven over a period of 10 hours, let stand at room temperature for 24 hours and then heated again at 76.6° C. for another 10 hours.

### Experiment #2 Results

The linseed oil and the conventional soybean oil would begin to form a polymerized film on the outer surface with 10-12 hours, but the specialty oil remains stable for 3-4 times the hours before it forms a film on the surface of the oil.

The same oils, however, when spread in thin film on a metal or wood surface and exposed to the same temperature will results the all three oils forming films (oxidizing), but the specially oil would polymerize faster and with no stickiness as compared to the other oils.

This allows for rapid natural curing of the oil on surfaces of wood and other materials. Additionally, the oil due to its unique fatty acid structure presents relatively a high resistance to natural oxidation while in volume. But, it quickly and fully polymerizes when it is in thin film.

This property of the oil allows the oil to remain stable and oily while in the machinery and treating equipment; but to change quickly when a thin layer on the surface of the treated wood is exposed to atmospheric oxygen. The benefits include easier handling of the product within the manufacturing process and decreased formation of polymers in the insides of the chambers, control valves and other components.

TABLE 2
Polymer formation in glass test tubes after treatment (Example of Oil
in Volume).

| | | After 10 hours | After an additional |
|---|---|---|---|
| Sample | | @ ° C. | 10 hours |
| # | Sample | (170 F.) | @ 170 F. |
| 1 | Soybean Oil | Same as time 0 | Same as time 0, no film |
| | (control) | | formation |
| 2 | Linseed Oil | Same as time 0 | Same as time 0, no film |
| | (control) | | formation |
| 3 | SDA Soybean Oil | Same as time 0 | Same as time 0, no film |
| | | | formation |
| 4 | Blown/heated SDA | Same as time 0 | Same as time 0, no film |
| | Soybean Oil | | formation |
| 5 | Polymerized | Same as time 0 | Same as time 0, no film |
| | Linseed | | formation |
| | Stand Oil | | |

TABLE 3
Polymer formation in glass films after treatment (Example of Oil in thin
film)
Table 3: Polymer formation in glass films after treatment
(Example of Oil in thin film)

| | | After 10 hours | After an additional |
|---|---|---|---|
| Sample | | @ ° C. | 10 hours @ |
| # | Sample | 170 F. | 170 F. |
| 1 | Soybean Oil | Same as time 0, | Same as time 0, |
| | (control) | no film formation | no film formation |
| 2 | Linseed Oil | Same as time 0 | Dry, not sticky |
| | (control) | | |
| 3 | SDA Soybean Oil | Same as time 0 | Dry, slightly sticky |
| 4 | Blown/heated SDA | Same as time 0 | Dry, not sticky |
| | Soybean Oil | | |
| 5 | Polymerized | Same as time 0 | Dry, not sticky |
| | Linseed | | |
| | Stand Oil | | |

### Experiment #3

### Materials

(1) Neat SDA Soybean Oil treated with TBHQ (Lot # SDA-1209-11023)
(2) Air Blown/heated SDA Soybean Oil (same lot as above)
(3) Soybean Oil (control)
(4) Boiled Linseed Oil (control)

Methods

Pressure treatment chamber was used to impregnate each oil into untreated pieces of yellow pine wood as described in U.S. Pat. No. 6,641,927. Multiple temperature, pressure and length of treatment combinations were tested as shown in results tables 5 and 6.

Each treatment unit was one piece of yellow pine with the following dimensions 3½″×1½″×6″ (about 31.5 sq inches in volume). The weight in grams of each wood piece was measured prior to treatment, immediately following treatment and after 24 hours, 1 week and 2 weeks. The difference between the weight prior to treatment and the weight in each time point was calculated to estimate weight increase/decrease over time due to oil absorption initially and any evaporation/water loss over time.

### Experiment #3 Results

Oil Analytics Table 4 shows the standard panel of analytical measurements for the SDA Soybean Oil. Of particular interest to certain lubricant applications is the higher viscosity index of about 30 points from the typical value for soybean oils reported in the prior art.

TABLE 4
SDA Soybean Oil Analytical Panel

| | | Omega-3 SDA Oil |
|---|---|---|
| Regular Testing | Standard | 12-052 |
| Flash and Fire Points (Cleveland Open Cup) | ASTM D92 | 339/360° C. |
| Flash Point (Pensky-Martens Closed Cup) | ASTM D 93 | 284° C. |
| Viscosity, Kinematic (@ 40° C.) | ASTM D445 | 24.68 |
| Viscosity, Kinematic (@ 100° C.) | ASTM D445 | 6.69 |
| Viscosity Index Calculation | ASTM D2270 | 251 |
| Viscosity, Kinematic (@ 40° C. of Hotplate | ASTM D445 | 25.89 |
| Oil) | | |
| Viscosity, Kinematic (@ 100° C. of Hotplate | ASTM D445 | 6.89 |
| Oil) | | |
| Viscosity Index Calculation (of Hotplate Oil) | ASTM D2270 | 248 |
| Viscosity, Kinematic (@ 40° C. of Microwave | ASTM D445 | 25.79 |
| Oil) | | |
| Viscosity, Kinematic (@ 100° C. of Microwave | ASTM D445 | 6.88 |
| Oil) | | |
| Viscosity Index Calculation (of Microwave Oil) | ASTM D2270 | 248 |
| Foaming Characteristics (Seq I) | ASTM D892 | 35 mL/0 mL |
| Foaming Characteristics (Seq II) | ASTM D892 | 0 mL/0 mL |
| Foaming Characteristics (Seq III) | ASTM D892 | 30 mL/0 mL |
| Dielectric Breakdown Voltage | ASTM D877 | 47.51 kV |
| OIL Stability Index (@ 110° C.) | AOCS Cd 12b-92 | 1.14 |
| OIL Stability Index (@ 165° C.) | AOCS Cd 12b-92 | 0.14 |
| Pour and Cloud Points | ASTM D6749/D97 | −8.0/−6.2° C. |
| RVPOT (with Water, no Catalyst) | ASTM D2272 | 25 minutes |
| RVPOT (with Water and Catalyst) | ASTM D2272 | 21 minutes |
| RVPOT (no Water, with Catalyst) | ASTM D2272 | 26 minutes |

Tables 5 and 6 show oil retention levels after different periods of time. In general increased length of treatment and pressures resulted in higher amounts of absorbed oil, as expected. Absorbed oil generally increased with temperature, although the Neat SDA Soybean Oil showed lower absorption levels at the 80 C treatment. The range of absorbed oil was between 5 and 143 grams per sample, which translates to less than 1 Lb to 17 Lbs/Cu Ft of wood, with at least ⅓ to ½ of the heat-temperature-length of treatment combinations above 7 Lbs per Sq Ft of treated wood (about 58 grams per sample).

TABLE 5
Pressure Treatment Wood Chamber Results with Neat Soybean Oil
Pressure Treatment of Wood with Neat SDA Soybean Oil

| | | | | | | | | | | | | | | | | |
|---|---|---|---|---|---|---|---|---|---|---|---|---|---|---|---|---|
| Treatment Temp. | 50 | C. | 50 | C. | 50 | C. | 50 | C. | 60 | C. | 60 | C. | 60 | C. | 60 | C. |
| Treatment Pressure | 40 | psi | 40 | psi | 80 | psi | 80 | psi | 40 | psi | 40 | psi | 80 | psi | 80 | psi |
| Treatment Length | 10 | m [symbol] n | 20 | m [symbol] n | 10 | m [symbol] n | 20 | m [symbol] n | 10 | m [symbol] n | 20 | m [symbol] n | 10 | m [symbol] n | 20 | m [symbol] n |

| | | | | | | | | |
|---|---|---|---|---|---|---|---|---|
| dryness | 242.5 | 240.5 | 244.2 | 245.5 | 241.7 | 247.0 | 239.5 | 271.2 |
| treated mass | 291.8 | 317.8 | 315.2 | 339.0 | 288.0 | 330.7 | 326.0 | 281.3 |
| 24 hour mass | 296.4 | 318.9 | 315.8 | 339.9 | 287.2 | 331.0 | 326.2 | 282.6 |
| 1 Week mass | 291.6 | 314.2 | 312.5 | * | 283.6 | 327.8 | 323.2 | 278.9 |
| 2 Week mass | 289.7 | 312.4 | 310.3 | * | 281.5 | 325.9 | 321.4 | 275.9 |

Delta in grams versus untreated

| | | | | | | | | |
|---|---|---|---|---|---|---|---|---|
| treated mass | 52 | 77 | 71 | 94 | 44 | 84 | 87 | 10 |
| 24 hour mass | 54 | 78 | 72 | 94 | 45 | 84 | 87 | 11 |
| 1 Week mass | 49 | 74 | 68 | * | 42 | 81 | 84 | 8 |
| 2 Week mass | 47 | 72 | 66 | * | 40 | 79 | 82 | 5 |

Pressure Treatment of Wood with Neat SDA Soybean Oil

| | | | | | | | | | | | | | | | | |
|---|---|---|---|---|---|---|---|---|---|---|---|---|---|---|---|---|
| Treatment Temp. | 70 | C. | 70 | C. | 70 | C. | 70 | C. | 80 | C. | 80 | C. | 80 | C. | 80 | C. |
| Treatment Pressure | 40 | psi | 40 | psi | 80 | psi | 80 | psi | 40 | psi | 40 | psi | 80 | psi | 80 | psi |
| Treatment Length | 10 | m [symbol] n | 20 | m [symbol] n | 10 | m [symbol] n | 20 | m [symbol] n | 10 | m [symbol] n | 20 | m [symbol] n | 10 | m [symbol] n | 20 | m [symbol] n |

| | | | | | | | | |
|---|---|---|---|---|---|---|---|---|
| dryness | 253.0 | 251.8 | 251.9 | 246.0 | 265.6 | 240.2 | 290.5 | 290.0 |
| treated mass | 295.3 | 311.3 | 263.3 | 257.4 | 277.7 | 248.8 | 262.5 | 260.5 |
| 24 hour mass | 293.6 | 299.0 | 262.0 | 256.6 | 276.8 | 247.4 | 280.5 | 258.7 |
| 1 Week mass | 290.7 | 295.0 | 258.3 | 253.3 | 272.7 | 245.9 | 258.7 | 256.8 |
| 2 Week mass | 288.5 | 293.3 | 256.4 | 251.8 | 271.7 | 244.7 | 257.0 | 254.8 |

Delta in grams versus untreated

| | | | | | | | | |
|---|---|---|---|---|---|---|---|---|
| treated mass | 42 | 60 | 11 | 11 | 12 | 9 | 12 | 11 |
| 24 hour mass | 41 | 47 | 10 | 11 | 11 | 7 | 10 | 9 |
| 1 Week mass | 38 | 43 | 6 | 7 | 7 | 6 | 8 | 7 |
| 2 Week mass | 37 | 42 | 4 | 6 | 6 | 5 | 7 | 5 |

[symbol]

indicates data missing or illegible when filed

TABLE 6
Pressure Treatment Wood Chamber Results with Air Blown/Heated Soybean Oil
Pressure Treatment of Wood with Air Blown + Heated Oxidized SDA Soybean Oil

| | | | | | | | | | | | | | | | | |
|---|---|---|---|---|---|---|---|---|---|---|---|---|---|---|---|---|
| Treatment Temp. | 50 | C. | 50 | C. | 50 | C. | 50 | C. | 60 | C. | 60 | C. | 60 | C. | 60 | C. |
| Treatment Pressure | 40 | psi | 40 | psi | 80 | psi | 80 | psi | 40 | psi | 40 | psi | 80 | psi | 80 | psi |
| Treatment Length | 10 | m [symbol] n | 20 | m [symbol] n | 10 | m [symbol] n | 20 | m [symbol] n | 10 | m [symbol] n | 20 | m [symbol] n | 10 | m [symbol] n | 20 | m [symbol] n |

| | | | | | | | | |
|---|---|---|---|---|---|---|---|---|
| Weight before the test | 201.2 | 199.5 | 199.3 | 208.1 | 199.0 | 201.6 | 199.3 | 199.1 |
| Weight after the test | 256.7 | 299.6 | 251.7 | 304.3 | 249.0 | 344.3 | 244.3 | 280.1 |
| Weight after 24 hours | 249.3 | 233.0 | 251.0 | 303.5 | 242.2 | 348.7 | 245.6 | 259.0 |
| Weight after one week | 249.4 | 292.0 | 250.1 | 301.9 | 240.9 | 342.1 | 245.6 | 250.9 |
| Weight after two weeks | 250.9 | 233.6 | 352.3 | 302.5 | 341.6 | 342.4 | 245.9 | 261.1 |

Delta in grams versus untreated

| | | | | | | | | |
|---|---|---|---|---|---|---|---|---|
| treated mass | 56 | 84 | 53 | 101 | 45 | 143 | 45 | 61 |
| 24 hour mass | 49 | 33 | 53 | 100 | 44 | 142 | 45 | 60 |
| 1 Week mass | 48 | 33 | 52 | * | 43 | 141 | 45 | 62 |
| 2 Week mass | 50 | 33 | 54 | * | 44 | 141 | 47 | 62 |

Pressure Treatment of Wood with Air Blown + Heated Oxidized SDA Soybean Oil

| | | | | | | | | | | | | | | | | |
|---|---|---|---|---|---|---|---|---|---|---|---|---|---|---|---|---|
| Treatment Temp. | 70 | C. | 70 | C. | 70 | C. | 70 | C. | 80 | C. | 80 | C. | 80 | C. | 80 | C. |
| Treatment Pressure | 40 | psi | 40 | psi | 80 | psi | 80 | psi | 40 | psi | 40 | psi | 80 | psi | 80 | psi |
| Treatment Length | 10 | m [symbol] n | 20 | m [symbol] n | 10 | m [symbol] n | 20 | m [symbol] n | 10 | m [symbol] n | 20 | m [symbol] n | 10 | m [symbol] n | 20 | m [symbol] n |

| | | | | | | | | |
|---|---|---|---|---|---|---|---|---|
| Weight before the test | 247.3 | 194.7 | 199.9 | 207.6 | 241.7 | 249.9 | 243.3 | 252.0 |
| Weight after the test | 301.2 | 258.3 | 268.8 | 316.4 | 302.3 | 318.8 | 343.8 | 357.0 |
| Weight after 24 hours | 299.9 | 255.1 | 269.2 | 316.8 | 302.1 | 317.9 | 343.3 | 316.7 |
| Weight after one week | 301.0 | 258.2 | 270.0 | 317.2 | 312.6 | 318.1 | 343.3 | 366.9 |
| Weight after two weeks | 300.9 | 259.2 | 269.8 | 317.4 | 299.4 | 314.7 | 341.5 | 263.9 |

Delta in grams versus untreated

| | | | | | | | | |
|---|---|---|---|---|---|---|---|---|
| treated mass | 53 | 64 | 79 | 109 | 61 | 69 | 101 | 115 |
| 24 hour mass | 53 | 60 | 79 | 109 | 60 | 69 | 100 | 115 |
| 1 Week mass | 54 | 65 | 80 | 110 | 61 | 68 | 100 | 115 |
| 2 Week mass | 54 | 65 | 80 | 110 | 58 | 65 | 97 | 12 |

[symbol]

indicates data missing or illegible when filed

The weight loss over time observed in all treatments was low, suggesting the formation of a water tight barrier had been formed that prevented evaporation of any moisture existing in the wood.

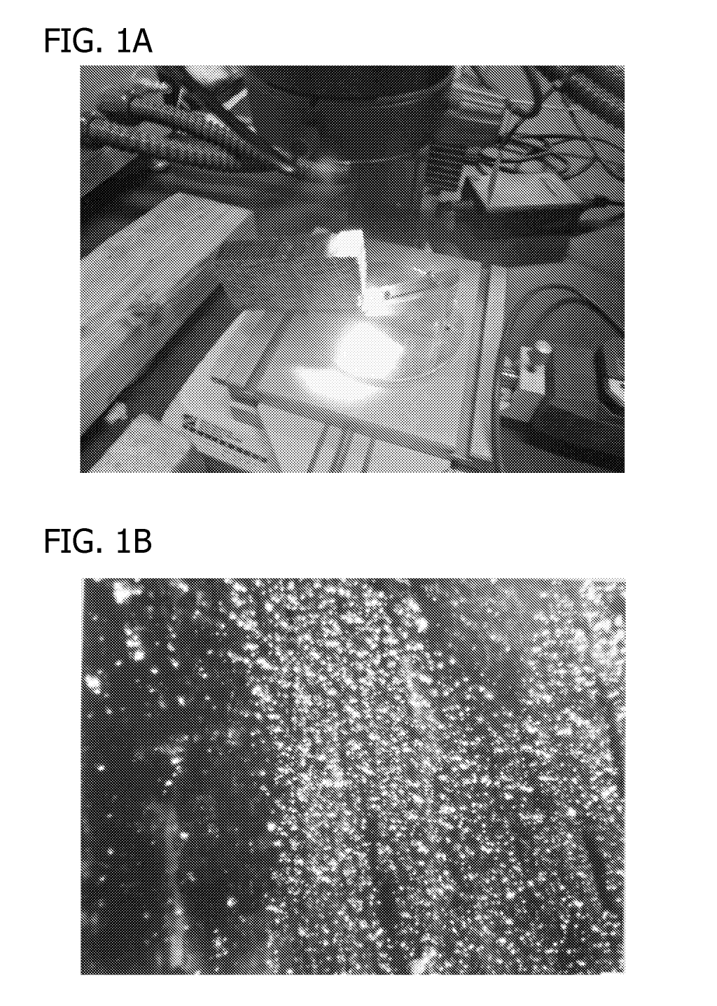

FIG. 1 confirms visual observations by researchers of a polymer coating of the wood after treatment with SDA Soybean Oil (neat or blown), which dried to touch and was non tacky after a short period of time (hours). Similar experiments with other vegetable oils, in particular Soybean Oil, have not yielded a polymer coat on the wood and provided a surface which remained tacky for months after treatment.

In another experiment, samples of a section of 3″×4″ manufactured wood and section of kiln dried 3″×4″ softwood were pressurized in treating chamber with neat SDA oil. Treating times were four and five hours at 100 psi pressure and 100° C. (212° F.) to determine absorption rate. The following Table presents the results. All samples were dry to the touch within 24 hours.

The composition of the oil was as follows:

TABLE 7
SDA Oil Composition

| Fatty acid composition (FAC, %) | |
|---|---|
| C14:0 (Myristic) | 0.07 |
| C16:0 (Palmitic) | 12.4 |
| C16:1 (trans-Hexadecanoic) | 0.01 |
| C16:1n7 (Palmitoleic) | 0.12 |
| C17:0 (Margaric) | 0.13 |
| C18:0 (Stearic) | 4.14 |
| C18:1 (trans-Octadecenoic) | 0.07 |
| C18:1n9 (Oleic) | 14.6 |
| C18:1 (Octadecenoic) | 1.34 |
| C18:2 (trans-Octadecadienoic) | 0.12 |
| C18:2n6 (Linoleic) | 18.5 |
| C18:3 (trans-Octadecatrienoic) | 0.3 |
| C18:3n6 (Gamma linolenic) | 7.29 |
| C18:3n3 (Alpha linolenic) | 10.5 |
| C18:4 (trans-Octadecatetraenoic) | 0.35 |
| C18:4n3 (Octadecatetraenoic) | 28.7 |
| C20:0 (Arachidic) | 0.37 |
| C20:1n9 (Eicosenoic) | 0.26 |
| C20:2n6 (Eicosadienoic) | 0.04 |
| C22:0 (Behenic) | 0.32 |
| C22:1 (Erucic) | — |
| C24:0 (Lignoceric) | 0.05 |
| Others | 0.37 |
| Total | 100.1 |

### Coating Formulations Containing Drying Catalysts

Oil drying can be enhanced by the addition of drying catalysts; these catalysts are typically cobalt, copper and manganese carboxylates. The metal compounds can catalyze the cross-linking of double bonds in the coating vehicle. Such formulations are discussed in The Printing Ink Manual, 5th ed., R. H. Leach and R. J. Pierce, eds., Springer, Dordrecht, the Netherlands, 2007, pp. 390-431.

SDA soy oil takes the place of the linseed oil in varnishes, wood stains and other protectants and is expected to provide more desirable properties because it can be present in a higher concentration than in a typical linseed alkyd coating formulation.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above particles and processes without departing from the scope of the invention, it is intended that all matter contained in the above description and shown in the accompanying drawings shall be interpreted as illustrative and not in a limiting sense.

### LITERATURE CITED AND INCORPORATED BY REFERENCE

These references are specifically incorporated by reference relevant to the supplemental procedural or other details that they provide.
DICTIONARY OF FOOD SCIENCE AND TECHNOLOGY, p 141, 151 (Blackwell publ.)(Oxford UK, 2005).
ECONOMIC EVALUATION OF ALTERNATE MATERIALS TO TREATED WOOD IN CALIFORNIA, Stephen T. Smith, P. E. (2003).
Honary et al., U.S. Pat. No. 6,641,927, SOYBEAN OIL IMPREGNATION WOOD PRESERVATIVE.
WO2009042770,—David A. Morgenstern et al., POLYUNSATURATED FATTY ACIDS IN PLASTICS AND SURFACE COATINGS (published Apr. 2, 2009)
BIOBASED LUBRICANTS AND GREASES: TECHNOLOGY AND PRODUCTS, By Lou Honary, (Erwin Richter, Wiley publishers) page 30-32.
Finley, J. W., OMEGA-3 FATTY ACIDS: CHEMISTRY, NUTRITION, AND HEALTH EFFECTS, (ed. John W. Finley) (Publ. American Chemical Society, Wash. D.C.)(ACS Symposium, May 2001)(Series Volume:105-37788).
Gelvin et al., PLANT MOLECULAR BIOLOGY MANUAL, (Kluwer Academic Publ. (1990)).
Myers, R. A. and Worm, B., Rapid World Wide Depletion of Predatory Fish Communities, NATURE 423: 280-83 (2003).
Ursin, V. M., Modification Of Plant Lipids For Human Health: Development of Functional Land-Based Omega-3 Fatty Acids Symposium: Improving Human Nutrition Through Genomics, Proteomics And Biotechnologies. J. NUTR. 133: 4271-74 (2003).
Weissbach and Weissbach, METHODS FOR PLANT MOLECULAR BIOLOGY, (Academic Press, (1989)).

1.-42. (canceled)

43. A method for coating a substrate comprising applying a coating composition to the substrate, wherein the coating composition comprises a drying oil composition comprising at least one polyunsaturated fatty acid having three or more carbon-carbon double bonds or a derivative thereof and a second composition and wherein the drying oil composition comprises either:
(a) at least 5.5 wt. % of the at least one polyunsaturated fatty acid having four or more carbon-carbon double bonds or a derivative thereof and at least 16.5 wt. % of linoleic acid or a derivative thereof based upon the total weight of fatty acids or derivatives thereof in the drying oil composition;
(b) at least 5.5 wt. % of the at least one polyunsaturated fatty acid having four or more carbon-carbon double bonds or a derivative thereof, less than 14.5 wt. % of palmitic acid or a derivative thereof, and at least 3.5 wt. % linoleic acid or a derivative thereof based upon the total weight of fatty acids or derivatives thereof in the drying oil composition; or
(c) at least 7.5 wt. % stearidonic acid or a derivative thereof based upon the total weight of fatty acids or derivatives thereof in the drying oil composition;
wherein the drying oil has a viscosity index from about 230 to about 270.

44. The method of claim 43 wherein the coating composition is a paint, varnish, lacquer or stain.

45. The method of claim 44 wherein the coating composition is a lacquer.

46. The method of claim 44 wherein the coating composition is varnish.

47. The method of claim 43 wherein the drying oil has a viscosity index from about 240 to about 260.

48. The method of claim 43 wherein the drying oil has a viscosity index from about 245 to about 255.

49. The method of claim 43 wherein substrate is a wood article.

50. The method of claim 49 wherein the wood article comprises creosote.

51. The method of claim 43 wherein the drying oil comprises a heat treated stearidonic acid oil comprising from 7.5 wt. % to 30 wt. % stearidonic acid.

52. The method of claim 43 wherein the coating composition further comprises a gelling agent.

53. The method of claim 52 wherein the gelling agent comprises an organometallic compound of aluminum or a polyamide resin.

54. The method of claim 53 wherein the organometallic compound of aluminum comprises an aluminum soap, an aluminum alkoxide, or an oxyaluminum acylate.

55. The method of claim 54 wherein the oxyaluminum acylate comprises oxyaluminum octoate.

56. The method of claim 52 wherein the gelling agent further comprises a stabilizer.

57. The method of claim 56 wherein the stabilizer is selected from 2,4,5-trihydroxybutyrophenone, 2,6-di-t-butylphenol, 3,4-dihydroxybenzoic acid, 3-t-butyl-4-hydroxyanisole, 4-hydroxymethyl-2,6-di-t-butylphenol, 6-ethoxy-1,2-dihydro-2,2,4-trimethylquinoline, anoxomer, ascorbic acid, ascorbyl palmitate, ascorbyl stearate, beta-apo-8′-carotenoic acid, beta-carotene, butylated hydroxyanisole (BHA), butylated hydroxytoluene (BHT), caffeic acid, calcium ascorbate, calcium disodium EDTA, canthaxanthin, carnosol, carvacrol, catalase, cetyl gallate, chlorogenic acid, citric acid, clove extract, coffee bean extract, D-α-tocopheryl acetate, dilauryl thiodipropionate, disodium citrate, disodium EDTA, DL-α-tocopherol, DL-α-tocopheryl acetate, dodecyl gallate, dodecyl gallate, D-α-tocopherol, edetic acid, erythorbic acid, esculetin, esculin, ethoxyquin, ethyl gallate, ethyl maltol, eucalyptus extract, ferulic acid, a flavonoid, a flavone, a flavanone, a chalcone, fraxetin, fumaric acid, gentian extract, gluconic acid, glucose oxidase, heptyl paraben, hesperetin, hydroquinone, hydroxycinammic acid, hydroxyglutaric acid, hydroxytryrosol, isopropyl citrate, lecithin, lemon juice solids, lemon juice, L-tartaric acid, lutein, lycopene, malic acid, maltol, methyl gallate, methylparaben, morin, N-hydroxysuccinic acid, nordihydroguaiaretic acid, octyl gallate, p-coumaric acid, phosphatidylcholine, phosphoric acid, p-hydroxybenzoic acid, phytic acid (inositol hexaphosphate), pimento extract, potassium bisulfite, potassium lactate, potassium metabisulfite, potassium sodium tartrate anhydrous, propyl gallate, pyrophospate, quercetin, ice bran extract, rosemary extract (RE), rosmarinic acid, sage extract, sesamol, sinapic acid, sodium ascorbate, sodium ascorbate, sodium erythorbate, sodium erythorbate, sodium hypophosphate, sodium hypophosphate, sodium metabisulfite, sodium sulfite, sodium thisulfate pentahydrate, sodium tryphosphate, soy flour, succinic acid, sucrose, syringic acid, tartaric acid, t-butyl hydroquinone (TBHQ), thymol, tocopherol, tocopheryl acetate, tocotrienols, trans-resveratrol, tyrosol, vanillic acid, wheat germ oil, zeaxanthin, α-terpineol, and a combination thereof.
